(19) United States
(12) Patent Application Publication
(10) Pub. No.: US 2026/0128047 A1
(43) Pub. Date: May 7, 2026

(54) AUDIO CODING WITH DEPTH AND BANDWIDTH SCALABILITY

(71) Applicant: GOOGLE LLC, Mountain View, CA (US)

(72) Inventors: Jean-Marc Valin, Montreal (CA); Arvindh Krishnaswamy, Palo Alto, CA (US); Jeffrey Ryan Peil, Livonia, MI (US)

(21) Appl. No.: 19/375,387

(22) Filed: Oct. 31, 2025

Related U.S. Application Data
(60) Provisional application No. 63/715,141, filed on Nov. 1, 2024.

(51) Int. Cl. G10L 19/038; G10L 19/00; G10L 19/002; G10L 19/02

(52) U.S. Cl. CPC G10L 19/038; G10L 19/002; G10L 19/0212; G10L 2019/0002

(57) ABSTRACT

Techniques are directed to an audio codec configured to process audio in such a way that enables the codec to decompress an encoded audio signal at an increased bandwidth and/or bit depth. In some implementations, the audio codec is configured to operate on audio data expressed in the Opus format. In such implementations, the Opus format enables such decompression at increased bandwidth while preserving backward compatibility with standard decompression in the Opus format. The decompression at increased bandwidth and/or bit depth is enabled via a set of extension bits in addition to a base set of bits that represent a set of compressed audio frames. In the case of Opus format, the additional bandwidth and/or bit depth may be specified in a header. In these cases, for decoders that do not enable such decompression at the increased bandwidth, they may ignore the extension bits to preserve backward compatibility.

### CROSS REFERENCE TO RELATED APPLICATIONS

This application claims the benefit of U.S. Provisional Application No. 63/715,141, filed on Nov. 1, 2024, the disclosure of which is hereby incorporated by reference in its entirety.

### BACKGROUND

An audio codec is software or a hardware device capable of encoding or decoding a digital data stream representing an audio signal. In software, an audio codec can take the form of a computer program implementing an algorithm that compresses and decompresses digital audio data according to a given audio file or streaming media audio coding format. An objective of the algorithm is to represent a high-fidelity audio signal with a minimum number of bits while retaining quality. This can effectively reduce the storage space and the bandwidth required for transmission of the stored audio file. Some audio compression and decompression algorithms are based on a modified discrete cosine transform (MDCT) and linear predictive coding (LPC).

An example of an audio coding format is the Opus format. Opus combines speech-oriented LPC-based SILK algorithm and a lower-latency MDCT-based CELT algorithm, switching between or combining them as needed. Bitrate, audio bandwidth, complexity, and algorithm choice can be adjusted for each individual frame. Opus has low algorithmic delay configured for use as part of a real-time communication link, networked music performances, and live lip sync.

### SUMMARY

Implementations described herein relate to an audio codec configured to process audio in such a way that enables the codec to decompress an encoded audio signal at an increased bandwidth beyond 20 kHz and/or bit depth. In some implementations, the audio codec is configured to operate on audio data expressed in the Opus format. In such implementations, the Opus format enables such decompression at increased bandwidth and/or bit depth while preserving backward compatibility with standard decompression in the Opus format. The decompression at increased bandwidth and/or bit depth is enabled via a set of extension bits in addition to a base set of bits that represent a set of compressed audio frames. For example, in the Opus format, the set of extension bits may be stored in a padding layer within an audio data packet. In the case of Opus format, the additional resolution and/or bandwidth may be specified in a data packet header. In these cases, for decoders that do not enable such decompression at the increased resolution and/or bandwidths, the decoders may simply not receive or ignore the extension bits to preserve backward compatibility and allow Opus formats to use the extension bits whether the encoders are configured for increased resolution and/or bandwidths or not. Such extension bits enable high resolution audio for devices such as earbuds, and the framework enabling the extension bits can be released via open source and may be configured for a broad industry standard.

In one general aspect, a method can include receiving, by a decoder of an audio codec using a vector quantizer having a codebook that includes a first number of entries, a bitstream including a set of base bits, the set of base bits representing a compressed frame of an audio signal. The method can also include, in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution. The method can further include, in response to the decoder not receiving the set of extension bits, decoding the compressed frame of the audio signal at the initial resolution using the codebook having the first number of entries.

In another general aspect, a computer program product comprising a nontransitory storage medium, the computer program product including code that, when executed by a processor, causes the processor to perform a method. The method can include receiving, by a decoder of an audio codec using a vector quantizer having a codebook that includes a first number of entries, a bitstream including a set of base bits, the set of base bits representing a compressed frame of an audio signal. The method can also include, in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution. The method can further include, in response to the decoder not receiving the set of extension bits, decoding the compressed frame of the audio signal at the initial resolution using the codebook having the first number of entries.

In another general aspect, an apparatus can include memory and a processor coupled to the memory. The processor can be configured to receive, by a decoder of an audio codec using a vector quantizer having a codebook that includes a first number of entries, a bitstream including a set of base bits, the set of base bits representing a compressed frame of an audio signal. The processor can also be configured to, in response to the decoder receiving the set of extension bits that extends the codebook, the set of extension bits representing data enabling the decoder to increase a resolution used by the decoder to an extended resolution greater than an initial resolution by an extension of the codebook from the first number of entries to a second number of entries, decode the compressed frame of the audio signal at the extended resolution. The processor can also be configured to, in response to the decoder not receiving the set of extension bits, decode the compressed frame of the audio signal at the initial resolution using the codebook having the first number of entries.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example use of an extended audio decoder according to the improved techniques described herein.

FIG. 2 is a diagram illustrating an example audio data packet for decompression according to the improved techniques described herein.

FIG. 3 is a diagram illustrating an example electronic environment in which the above-described improved audio decompression may be performed, according to an aspect.

FIG. 4 is a flow chart illustrating an example process of performing the improved audio decompression, according to an aspect.

### DETAILED DESCRIPTION

Implementations described herein relate to extending the capabilities of audio quality codecs. A technical challenge associated with extending such capabilities, for example to support higher resolution audio, is maintaining backward compatibility with existing decoders and previously established formats. This disclosure describes a system that improves backward compatibility for digital audio. For example, when listening to music or participating in a meeting on a video call, the sound that is heard is compressed to save data that may be exchanged over a network or saved on a drive. Disclosed implementations allow an audio stream to contain a standard-quality version and an optional, hidden high-quality enhancement without any changes to the decoder or audio format. For example, a media server may transmit a single bitstream that contains a base layer and/or both the base layer and an extension layer. This bitstream can be sent to multiple client devices with differing capabilities. For example, a first client device, which may be an older hardware model, can be configured to receive the base layer of the bitstream, decoding a standard-quality audio signal. Concurrently, a second client device, which may be a newer hardware model with an updated decoder, can be configured to receive both the base layer and the extension layer, enabling it to decode a higher-fidelity version of the same audio signal from the single, unified bitstream.

Using the disclosed techniques in a music streaming example, a user with an older phone or a poor internet connection might receive and play the standard-quality audio seamlessly. However, a user with a new phone and a fast connection could have their device detect and use the extra data to play the music in a much richer, higher fidelity (e.g., “HD Audio”) format. This happens without needing a separate, dedicated high-quality stream.

Similarly, in a teleconferencing example, a company might have a mixture of new and old hardware. A new conference room system could use the enhanced data to provide crystal-clear, wideband audio, making voices sound more natural. Meanwhile, an employee dialing in from an older laptop would still hear the conversation, just at the standard quality their device supports. The disclosed techniques ensure everyone can participate, while those with capable devices can get a better experience. An innovation in this case is a method for encoding this extra quality information into the audio data stream so that older devices simply ignore it, while newer, compatible devices can use it to unlock enhanced audio.

As used herein, the term “bitstream” refers to a sequence of bits corresponding to an audio data packet. An audio data packet may include a header and one or more compressed audio frames, used to store or transmit digital audio data. A bitstream can be divided into a set of base bits, decodable by a conventional decoder, and a set of extension bits that provide additional information for enhanced decoding.

As used herein, the term “audio codec” refers to a device or computer program that implements an algorithm to compress and decompress digital audio data. An audio codec typically includes an encoder for compression and a decoder for decompression. An example of an audio codec is the Opus codec.

As used herein, the term “pyramid vector quantizer” (PVQ) refers to a form of vector quantization used in audio and video compression and decompression. It is a gain-shape quantizer that projects a vector onto the surface of a multi-dimensional pyramid or octahedron, which in turn is projected onto a unit sphere. The vector that is projected may represent a segment of an audio signal. Use of the PVQ in compression and decompression allows for efficient encoding and decoding of the vector's direction (shape) and magnitude (gain).

As used herein, the term “initial resolution” can refer to the range of audio frequencies, for example up to 20 kHz, that a conventional or non-extended decoder is configured to process when decoding a compressed audio signal. This bandwidth corresponds to the information contained in the set of base bits of a bitstream.

As used herein, the term “extended resolution” can refer to a range of audio frequencies that is greater than the initial bandwidth. This higher-fidelity bandwidth is achieved by a decoder that is configured to read and process a set of extension bits from a bitstream, which contains the data used to reconstruct the additional frequency information.

Some audio codecs such as the Opus codec were designed to operate at sampling frequencies up to 48 kHz, with an audio bandwidth up to 20 kHz. The CELT mode that is used for high bitrate coding uses a vector quantization with a mostly implicit bit allocation system that is dictated by the bitstream definition. Opus can allocate up to 8 bits per modified discrete cosine transform (MDCT) bin in some of the bands.

Conventional approaches to decompressing encoded audio involve using a standard codec such as an Opus encoder/decoder to store and transmit audio to a user that has a peak bandwidth of 20 kHz at a sampling rate of 48 kHz. This bandwidth corresponds to the full range of human hearing in a healthy human being. Nevertheless, a technical problem with the conventional approaches is that the bandwidth can be limited in some situations. For example, there is a use for codecs that scale beyond a 20 kHz bandwidth, including 24-bit/96 kHz codecs, as well as applications in which the intended recipient may not be a human being, e.g., ultra-sonic applications.

Moreover, with regard to increasing the limited bandwidth, another technical problem with the conventional approaches includes incompatibility of the decoding mechanism with decompression at an increased bandwidth and/or bit depth. For example, a typical codec that compresses at, for example, 20 kHz, will not be able to compress any bandwidths greater than 20 kHz without an update to the codec itself. Such a codec may not be able to operate on older devices and there would be a lack of backward compatibility.

Disclosed implementations provide a technical solution to the technical problem of compressing and decompressing high-resolution audio while providing backward compatibility of the codec so that both more advanced audio playback devices and older or less-sophisticated playback devices can use the same audio codec and audio files to store and transmit audio even though the audio on the more advanced audio playback devices may be decompressed at a higher resolution and/or bandwidth than that on the older or less-sophisticated playback devices. Such increased resolution and backward compatibility are made possible in the Opus format using a header and padding layer in an audio data packet that is a standard feature in the Opus format. While a bitstream defining the audio data packet includes a set of base bits that represents compressed audio frames corresponding to audio at bandwidths up to 20 kHz and a set of extension bits. The set of extension bits represents data enabling the decoder to increase a bandwidth used by the decoder to an extended bandwidth greater than 20 kHz. In some implementations in which the decoder corresponds to the Opus format, the padding layer of the audio data packet stores the set of extension bits. Moreover, in some implementations, the header of the audio data packet stores a number indicating an additional bandwidth.

Moreover, the quantization used in the encoding and decoding of the audio files includes a pyramid vector quantization (PVQ). The PVQ is used in Opus codecs for shape encoding in a band, where the gain is encoded separately from the shape of a spectrum in a band of a frame. The PVQ has an implicitly defined codebook whose size can be extended by an odd integer factor when the bandwidth is to be extended. When the size of the PVQ codebook exceeds a threshold size, e.g., 32 bits, a cubic quantizer may be used that, instead of mapping a vector to a face of an octahedron, maps a vector to a face of a cube in encoding and then to a unit sphere in decoding.

The technical solution disclosed is directed to improving the processing of digital audio data. The disclosed techniques improve upon the conventional approaches by enabling backward-compatible scalability of audio resolution. Specifically, a specially configured audio decoder, operating on a computing device, can receive a single bitstream containing both a base layer of compressed audio data and an optional extension layer. The base layer is decodable by any standard-compliant decoder, ensuring backward compatibility. The extension layer, however, contains data that enables a specially configured decoder to reconstruct the audio signal at an extended resolution, such as a higher bandwidth or increased bit depth.

The technical solution overcomes a significant problem in the field of digital audio processing: how to improve audio quality without rendering existing hardware and software obsolete. By embedding the enhancement data in a portion of the bitstream that legacy decoders are designed to ignore (e.g., a padding layer in an Opus packet), the system allows a single audio stream to serve both legacy devices and new, high-fidelity devices. For example, a processor configured with the disclosed extended audio decoder first decodes the base layer from a set of base bits in the bitstream using a vector quantizer with a first codebook. Then, if a set of extension bits is present, the processor uses these bits to extend the vector quantizer's codebook, which in turn allows for the decoding of the same audio frame at a higher resolution. This process involves specific mathematical operations, such as scaling the codebook size by an odd integer factor, to decode the additional audio information. If the codebook size exceeds a computational threshold, the processor is configured to use a more efficient cubic quantizer. This improves the functioning of the computer itself by enabling more efficient and flexible audio decoding, reducing the need for multiple, separate audio streams for different quality levels, thereby saving bandwidth and storage.

A technical advantage of the above-described technical solution is that the codec has the ability to decompress audio frames with an enhanced bandwidth and/or bit depth without losing backward compatibility. Accordingly, the above-described codec can provide high-definition audio for devices that are compatible with such audio while providing standard-definition audio for older, less-sophisticated devices. Moreover, the quantization scheme described above enables the bandwidth enhancement.

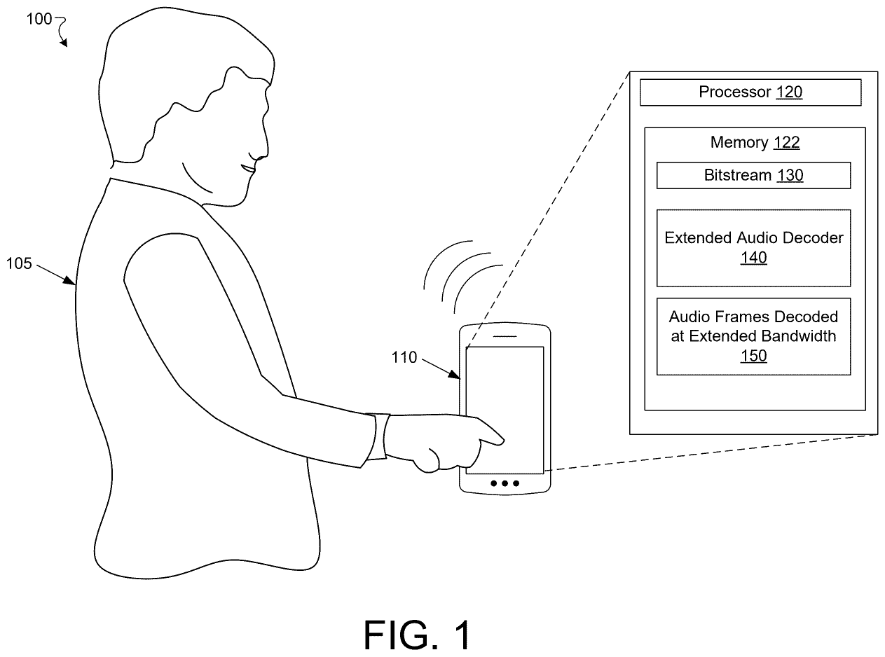

FIG. 1 shows a diagram of an audio decoding system 100 configured to implement bandwidth scalability while maintaining backward compatibility. The system 100 involves a user 105 interacting with an electronic device 110, such as a smartphone, tablet, or other computing device. The device 110 is equipped with suitable hardware and software to process advanced audio formats, as described herein. This configuration allows the user 105 to experience high-resolution audio playback when available, without compromising the ability to play standard-resolution audio files.

The device 110 includes a processor 120 and a memory 122. The processor 120 is responsible for executing instructions and processing data stored in the memory 122. The memory 122 stores various components suitable for the audio decoding process. These components include an incoming audio bitstream 130, an extended audio decoder 140, and the resulting decoded audio frames 150. The interplay between these components facilitates the decoding of audio signals at either a standard, initial bandwidth or an enhanced, extended bandwidth.

Processing audio as described above begins with the reception of a bitstream 130 by the device 110. This bitstream 130 contains compressed audio data structured in a specific format, such as the Opus codec format defined in RFC 6716. The Opus format is highly versatile, supporting both speech and music, and is designed for interactive, real-time applications over the Internet. The codec configured to process Opus audio files packages compressed audio data into packets, which can contain one or more frames. The techniques described here leverage this packet structure to include additional data for bandwidth extension. The bitstream 130 thus contains not only the base information for standard decoding but also extension data for high-resolution playback.

A primary component within the memory 122 is the extended audio decoder 140. This is a specialized software module, executed by the processor 120, that is capable of interpreting both the base bits of the bitstream 130 and the optional extension bits when the extended audio encoder is capable of increasing the bandwidth of the audio. Unlike a conventional decoder, the extended audio decoder 140 is specifically designed to recognize and utilize the extension bits to reconstruct the audio signal with a higher bandwidth than what would otherwise be possible. This enables the reproduction of audio frequencies beyond the typical 20 kHz limit of many standard audio systems.

In some implementations, the output of the extended audio decoder 140 is a series of audio frames 150 decoded at extended bandwidth. When the decoder 140 successfully processes the extension data within the bitstream 130, the resulting audio frames 150 represent a high-resolution audio signal. This provides a richer, more detailed listening experience for the user 105. If the bitstream 130 lacks extension data or if the decoder 140 is configured to operate in a legacy mode, it will ignore the extension capability and produce standard-bandwidth audio, ensuring backward compatibility.

In some implementations, the extended audio decoder 140 uses a pyramid vector quantizer to perform the vector quantization. Vector quantization is used by an encoder to convert a continuous range of audio amplitudes into a finite, discrete set of values. In the case of an Opus codec, there is a vector quantization used to convert amplitudes corresponding to a series of bits of an audio signal. In some implementations, the vector quantization is performed by a pyramid vector quantizer (PVQ), which is used to quantize the shape of a band separately from the gain of the band in an audio frame. The PVQ has an implicit codebook of a size defined as a number to which the absolute values of the quantized vectors sum. When that size exceeds a threshold size, e.g., 32 bits, the quantization scheme may use a cubic quantization scheme, in which during encoding the vectors are mapped to the faces of a cube in N dimensions rather than an octahedron in N dimensions.

A use case for the system 100 involves the user 105 streaming music or participating in a high-fidelity voice call using device 110, e.g., a smartphone. For instance, a music streaming service might offer a premium, high-resolution audio tier. When the user 105 subscribes to this service, the application on their device 110 receives a bitstream 130 that includes extension data. The extended audio decoder 140 within the device 110 processes this bitstream, resulting in decoded audio frames 150 that capture the full extended bandwidth of the original studio recording. If, in contrast, the user 105 switches the device 110 to an older model because, e.g., the newer device became unavailable, then the extended audio decoder 140 decompresses the audio frames at a standard bandwidth, e.g., less than or equal to 20 kHz. In some implementations, the music may be heard by the user 105 using headphones such as earbuds. In such a case, the decoding may be performed by the earbuds and the resolution or bandwidth of the decoding may depend on whether the earbuds are an older model that can only receive the set of base bits or the base and extension bits.

Another use case involves a teleconferencing application running on the device 110. To provide superior voice clarity, the application could encode the user's speech using an extended bandwidth when network conditions permit. The bitstream 130 sent to other participants would contain this extension data. If a receiving device is equipped with the extended audio decoder 140, it can decode the voice signal at the higher bandwidth, making the user's 105 voice sound more natural and clearer. If a participant's device has an older, non-compliant decoder, it will simply decode the base portion of the bitstream 130, ensuring the call can still proceed without interruption, albeit at a standard bandwidth.

The Opus file format, as detailed in RFC 6716, provides a flexible container for this functionality. An Opus data packet can contain multiple Constant Bit-Rate (CBR) or Variable Bit-Rate (VBR) frames. The specification allows for a padding layer at the end of a packet. In some implementations, the extension bits used for bandwidth scalability are embedded within this padding space. An older decoder, following the original specification, would simply place zeroes in the padding layer and ignore the padding, thus ignoring the extension data. In contrast, the extended audio decoder 140 is programmed to look for and interpret this specific extension data within the padding, allowing it to reconstruct the higher-frequency components of the audio signal.

The architecture of system 100 provides a technical advantage of enabling a single bitstream to support decoders with different processing capability. Put another way, it allows content creators and service providers to distribute a single audio bitstream 130 that caters to both new, high-resolution-capable devices like device 110 and older, legacy devices. The user 105 of an advanced device 110, e.g., a new smartphone, benefits from the improved audio quality offered by the extended bandwidth, while users with older equipment can still consume the content without compatibility issues. This seamless scalability is achieved by cleverly embedding the enhancement data in a way that is transparent and non-disruptive to legacy decoders.

Thus, FIG. 1 depicts a complete ecosystem for scalable audio decoding. The user 105 utilizes a device 110 containing a processor 120 and memory 122. The memory 122 holds the key software and data: the incoming bitstream 130, the extended audio decoder 140, and the high-quality output audio frames 150. This system 100 effectively solves the problem of deploying higher-fidelity audio without breaking compatibility with the vast number of existing decoders and audio files, representing a practical and efficient path forward for high-resolution audio distribution.

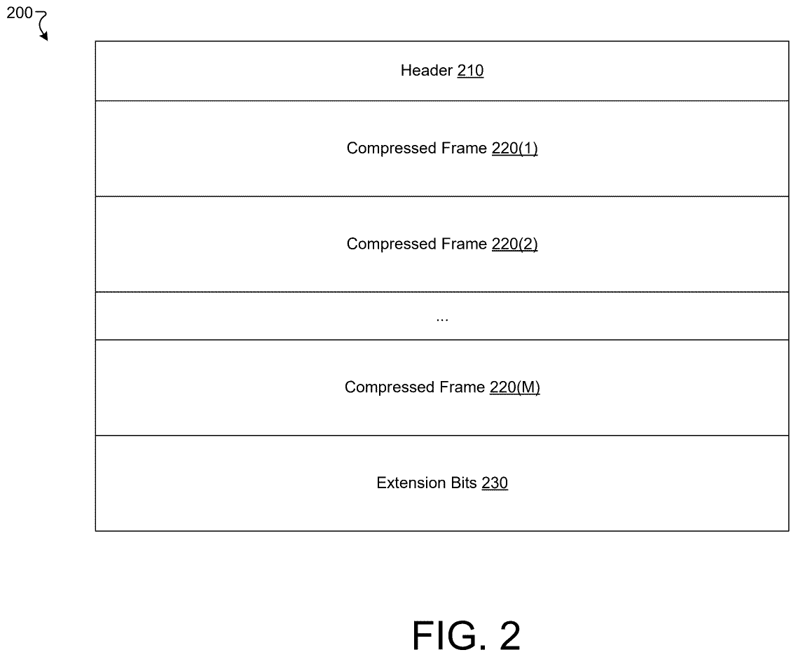

FIG. 2 shows a diagram of an example audio data packet 200, represented by a bitstream, consistent with the Opus Interactive Audio Codec as defined in RFC 6716. The audio data packet 200 is structured to ensure backward compatibility with legacy decoders while providing a mechanism for enhanced audio decoding by newer, more capable decoders. The primary components illustrated are a header 210, a series of M compressed frames designated as compressed frame 220(1) through compressed frame 220(M), and a final block of extension bits 230. This structure allows a standard decoder to process the header and compressed frames while an advanced decoder can utilize the additional extension bits for higher-fidelity audio reproduction.

The audio data packet 200 begins with the header 210, which contains metadata for interpreting the subsequent frames. The header 210 may start with a table of contents (TOC) byte that provides information such as the codec mode (e.g., SILK, CELT, or Hybrid), audio bandwidth, frame duration, number of channels (mono or stereo), and the number of frames contained within the packet. The header 210 can enable the forward-compatible extension mechanism. For instance, the header 210 could include a specific bit flag, or utilize reserved bits, to signal the presence of the extension bits 230 at the end of the packet. A legacy decoder, not programmed to recognize this signal, can process the audio data packet 200 based on standard frame information and simply disregard any data following the expected number of compressed frames.

Following the header 210 are the compressed audio frames, represented in the diagram as compressed frame 220(1), compressed frame 220(2), and so on, up to compressed frame 220(M). The compressed frames 220 contain the payload of encoded audio data for a specific time segment. The size of a frame can be constant in a Constant Bit Rate (CBR) packet or variable in a Variable Bit Rate (VBR) packet, with the size information typically encoded within the header 210 or a preceding frame length field. The collective data from the header 210 and M compressed frames 220 constitutes what a standard Opus decoder would process to reconstruct the audio signal at a predefined, initial bandwidth (e.g., up to 20 kHz “fullband”) and bit depth.

The final component of the audio data packet 200 is the block of extension bits 230. This block contains supplementary data that enables a suitably configured decoder (e.g., extended audio decoder 140) to enhance the audio beyond the baseline quality. In some implementations, the extension bits 230 carries information to extend the audio bandwidth beyond the standard 20 kHz, increase the sampling rate greater than 48 kHz, and/or improve the quantization resolution. To maintain compatibility, this data may be placed in what would otherwise be considered padding in the Opus packet structure. Specifically, for Opus packets with multiple frames per packet (Code 3), the specification allows for padding at the end of the packet. The extension bits 230 can be embedded within this padding area, ensuring that older decoders that strictly adhere to the frame length information from the header 210 will ignore this section.

A use case for this structure involves high-resolution audio. For example, the base data within the compressed frames 220(1) through 220(M) could represent a 20 kHz bandwidth audio signal. A standard decoder may decode this to produce high-quality audio. The extension bits 230, however, could contain additional encoded frequency information, for example, from 20 kHz up to 48 kHz, effectively enabling a 96 kHz extended sampling rate and a corresponding extended bandwidth. A decoder configured to read the extension bits 230 would first perform the initial decoding of the base frames and then use the data from the extension bits 230 to synthesize the additional high-frequency content, resulting in a richer, higher-fidelity output.

Another use case concerns bit depth extension, which relates to the dynamic range and quantization resolution of the audio signal. The Pyramid Vector Quantizer (PVQ) used in Opus encodes spectral coefficients. The extension bits 230 could be used to represent an extension of the PVQ codebook, which in some implementations is the original PVQ codebook with additional entries. This effectively adds extra precision, or bits, to the quantized values. For example, the compressed frames 220 might contain data for a 16-bit audio representation. The extension bits 230 could then provide the least significant bits to expand this to a 20-bit or 24-bit representation. The information in header 210 would alert a capable decoder to look for these extension bits 230, which it would then combine with the base layer information to reconstruct the audio at a greater dynamic range.

The backward compatibility of this format can advantageously result in widespread adoption of the Opus format. An audio file encoded with the above-described structure can be streamed to a variety of devices. A modern audio system with an updated decoder could use the extension bits 230 to render a full, extended-bandwidth audio. Conversely, an older mobile device or smart speaker with a standard decoder would receive the same audio data packet 200, process the header 210 and compressed frames 220, and not receive or ignore the extension bits 230. The user would still hear a complete and correct audio stream, albeit at the standard, initial bandwidth. This graceful degradation ensures that the introduction of enhanced audio features does not create a fragmented ecosystem or render older hardware obsolete.

The header 210 is used for managing this dual-capability system. When an encoder creates the audio data packet 200, it can set the flags within the header 210 to indicate the presence of the extension bits 230. Such a flag can be a single bit in a reserved field or a specific value in the configuration string of the TOC byte. The decoder's logic then becomes as follows: upon parsing the header 210, the decoder checks for the flag. If the flag is present and the decoder is configured to handle extensions, the decoder proceeds to decode both the base frames and the extension bits 230. If the flag is absent, or if the decoder is not configured for extensions, the decoder processes the base frames and stops, thus preserving the intended compatibility.

In some implementations, the extension bits 230 contain their own metadata. The metadata can describe the nature of the extension—whether it is for bandwidth, sampling rate, quantization resolution, or a combination thereof. This allows for flexibility in the type and degree of enhancement. For instance, one bitstream might use the extension bits 230 solely for increasing the sampling rate, while another might use them to add high-frequency content and refine the quantization of the bass frequencies. This internal structure within the extension bits 230, signaled by the header 210, allows for a robust and extensible system.

Thus, FIG. 2 details an audio data packet 200 that layers enhancement data onto a standard-compliant audio packet. This structure comprises a header 210 containing metadata and signaling, a series of base compressed frames 220(1) through 220(M) for baseline decoding, and a block of extension bits 230 containing the enhancement data. This layered approach, where the extension bits 230 can be safely ignored by non-compliant decoders, provides a powerful method for introducing new audio features like extended bandwidth and bit depth while maintaining complete backward compatibility with the existing Opus ecosystem. The header 210 acts as the gatekeeper, directing capable decoders to the additional data present in the extension bits 230.

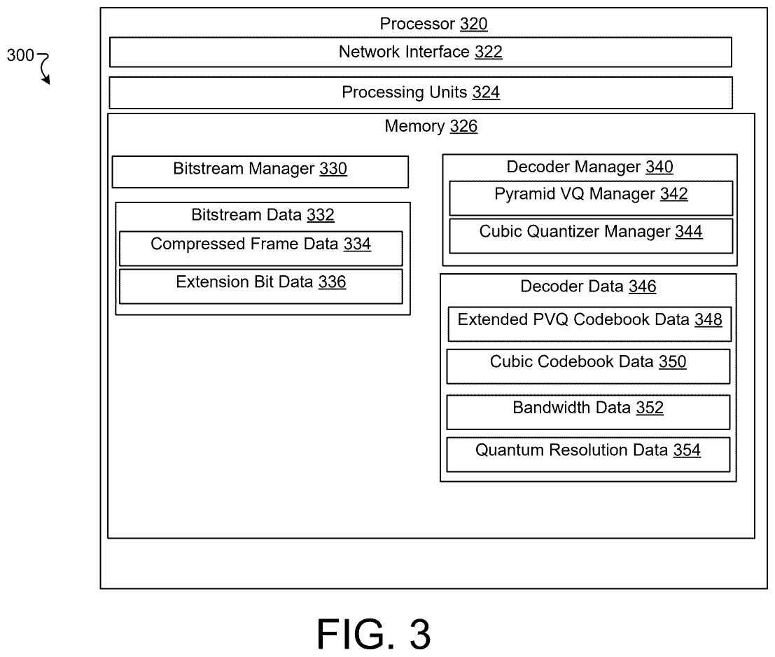

FIG. 3 is a diagram illustrating an example electronic environment 300 in which the above-described decoding of audio data packets may be performed. As shown in FIG. 3, the electronic environment 300 includes a processor 320 which is similar in function to the processor 120 of FIG. 1.

The processor 320 includes a network interface 322, one or more processing units 324, and the (nontransitory) memory 326. The network interface 322 includes, for example, Ethernet adaptors, Bluetooth adaptors, and the like, for converting electronic and/or optical signals received from the network to electronic form for use by the processor 320. The set of processing units 324 include one or more processing chips and/or assemblies. The memory 326 is a storage medium and includes both volatile memory (e.g., RAM) and non-volatile memory, such as one or more read only memories (ROMs), disk drives, solid state drives, and the like. The set of processing units 324 and the memory 326 together form part of the processor 320, which is configured to perform various methods and functions as described herein as a computer program product.

In some implementations, one or more of the components of the processor 320 can be, or can include processors (e.g., processing units 324) configured to process instructions stored in the memory 326. Examples of such instructions as depicted in FIG. 3 include a bitstream manager 330 and a decoder manager 340. Further, as illustrated in FIG. 3, the memory 326 is configured to store various data, which is described with respect to the respective managers that use such data.

The bitstream manager 330 is configured to receive, as bitstream data 332, a bitstream representing a compressed audio data packet. In some implementations, the bitstream manager is also configured to encode, or compress, audio data. For example, the audio data in uncompressed form may be compressed by the bitstream manager 330 to produce the bitstream data 332 representing compressed audio data packets.

During the compression of the audio data, the bitstream manager 330 may use a pyramid vector quantizer (PVQ) to generate the bitstream data 332. The pyramid vector quantizer has a codebook that provides the mapping of band shape to vectors corresponding to a surface of an octahedron inscribed in a sphere. In some implementations, the codebook may be lengthened, or extended, in order to provide an increased resolution. The extension of the codebook involves increasing the size of the codebook (e.g., number of entries) by a factor. In some implementations, the factor is an odd number. In some implementations, the factor takes the form 2^{b}−1, where b is a number corresponding to an extra depth.

As shown in FIG. 3, the bitstream data 332 includes compressed frame data 334 and extension bit data 336.

The compressed frame data 334 represents compressed audio frames in a data packet. A single frame can be subdivided into a series of frequency bands. These bands can be non-uniform, with narrower bands at lower frequencies and wider bands at higher frequencies, to better correspond to human auditory perception. For example, in a fullband (20 kHz) signal, there might be 21 distinct bands. A band is encoded separately, typically using a combination of techniques like Linear Prediction Coding (LPC) for lower frequencies and an Inverse Modified Discrete Cosine Transform (IMDCT) for higher frequencies. The energy and spectral shape (fine structure) of a band are quantized, often using pyramid vector quantization, and then encoded into the bitstream. This per-band encoding allows the codec to allocate bits efficiently, dedicating more data to the frequency ranges that are most used for perceived audio quality in that specific frame. The base layer decoding reconstructs these bands up to the initial bandwidth, while the extension data allows for the reconstruction of additional, higher-frequency bands.

The extension bit data 336 represents the extension bits that can be stored in the padding layer of the audio data packet. The extension bit data 336 provides a mechanism to increase the quantization resolution. In the context of PVQ, this can be visualized as increasing the number of available quantization points (the codebook size) for the spectral shape vectors. For example, a base layer might use a number of bits to select a vector from the PVQ codebook. The extension bits can provide additional bits, which effectively scale up the codebook. In some implementations, the scaling is designed to be an odd multiple of the original codebook size. For instance, if an additional bit depth of b bits is provided by the extension data, the new, larger codebook will have a size that is 2^{b}−1 times the size of the original codebook. This allows for a much finer, higher-resolution representation of the spectral shape, improving audio quality without breaking backward compatibility for decoders that do not read the extension bits. However, as the codebook size grows large, PVQ may become computationally intensive. In such cases, the system can be configured to use a different quantization scheme, such as a cubic quantizer, for these high-resolution bands.

The decoder manager 340 is configured to decompress encoded audio data packets, e.g., bitstream data 332 at either an enhanced bandwidth and/or bit depth or a standard bandwidth and/or bit depth. The decoder manager 340 operates based on decoder data 346, which represents code for the decoder including the LPC and IMDCT. As shown in FIG. 3, the decoder manager includes a pyramid vector quantizer (PVQ) manager 342 and a cubic quantizer manager 344.

The PVQ manager 342 is configured to apply the pyramid vector quantizer to vectors resulting from quantization in a frequency band and map it to a position on the unit sphere to produce an audio shape in a frequency band. The PVQ manager 342 operates on data that is encoded using the PVQ scheme. The PVQ manager 342 manages the codebooks and algorithms used to decode vectors that have been quantized onto the surface of a multi-dimensional pyramid. The PVQ manager 342 decodes the base layer of the audio signal represented in the compressed frame data 334.

The PVQ manager 342 is also configured to manage the extended PVQ codebook data 348. This data represents the extended codebook used by the pyramid VQ manager 342 when processing the extension bit data 336. The standard PVQ codebook is effectively enlarged or scaled by the bandwidth data 352 or the quantum resolution data 354, allowing for finer quantization and thus higher audio fidelity. The extended PVQ codebook data 348 enables the decoder to reconstruct the high-resolution components of the audio signal.

The cubic quantizer manager 344 is configured to perform quantization according to the cubic codebook data 350. The cubic quantizer manager 344 is configured to perform such quantization in the case that there is either no PVQ in the frequency band or if the size of the extended PVQ codebook data exceeds 32 bits.

The components (e.g., modules, processing units 324) of processor 320 can be configured to operate based on one or more platforms (e.g., one or more similar or different platforms) that can include one or more types of hardware, software, firmware, operating systems, runtime libraries, and/or so forth. In some implementations, the components of the processor 320 can be configured to operate within a cluster of devices (e.g., a server farm). In such an implementation, the functionality and processing of the components of the processor 320 can be distributed to several devices of the cluster of devices.

The components of the processor 320 can be, or can include, any type of hardware and/or software configured to process attributes. In some implementations, one or more portions of the components shown in the components of the processor 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 320 can be, or can include, a software module configured for execution by at least one processor (not shown). In some implementations, the functionality of the components can be included in different modules and/or different components than those shown in FIG. 3, including combining functionality illustrated as two components into a single component.

Although not shown, in some implementations, the components of the processor 320 (or portions thereof) can be configured to operate within, for example, a data center (e.g., a cloud computing environment), a computer system, one or more server/host devices, and/or so forth. In some implementations, the components of the processor 320 (or portions thereof) can be configured to operate within a network. Thus, the components of the processor 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, bitstream manager 330 (and/or a portion thereof) and decoder manager 340 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processor 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processor 320. As illustrated in FIG. 3, the memory 326 is configured to store various data, including bitstream data 332 and decoder data 346.

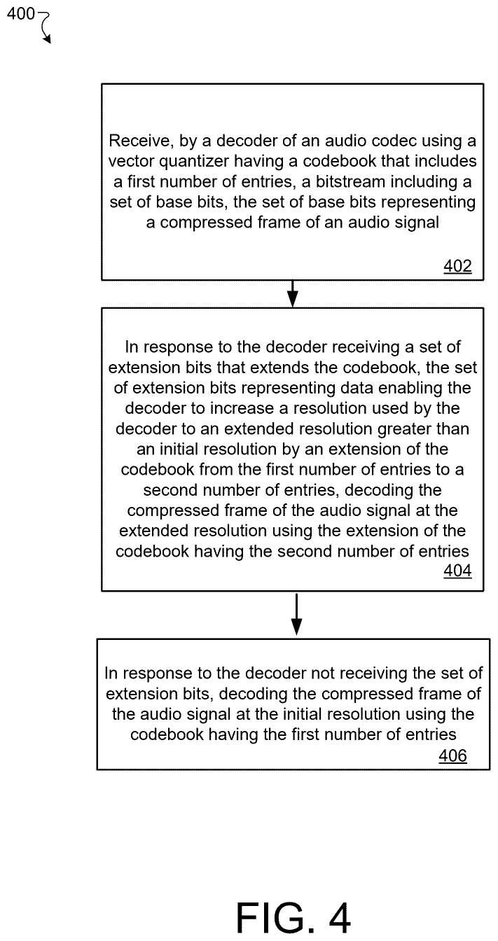

FIG. 4 is a flow chart illustrating an example process 400 of decoding of audio data packets. The process 400 may be carried out on a processor and memory such as processor 320 and memory 326 of FIG. 3.

At 402, a bitstream manager (e.g., bitstream manager 330) receives, by a decoder of an audio codec using a vector quantizer having a codebook that includes a first number of entries, a bitstream including a set of base bits, the set of base bits representing a compressed frame of an audio signal.

At 404, a decoder manager (e.g., decoder manager 340), in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decodes the compressed frame of the audio signal at the extended resolution using the extension of the codebook having the second number of entries.

At 406, the decoder manager, in response to the decoder not receiving the set of extension bits, decodes the compressed frame of the audio signal at the initial resolution using the codebook having the first number of entries.

Example 1. A method, comprising: receiving, by a decoder of an audio codec using a vector quantizer having a codebook that includes a first number of entries, a bitstream including a set of base bits representing a compressed frame of an audio signal; in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution using the extension of the codebook having the second number of entries.

Example 2. The method as in Example 1, wherein in response to the decoder not receiving the set of extension bits, decoding the compressed frame of the audio signal at the initial resolution using the codebook having the first number of entries.

Example 3. The method as in Example 1, wherein the vector quantizer is a pyramid vector quantizer.

Example 4. The method as in Example 3, wherein the second number of entries of the extension of the codebook of the pyramid vector quantizer is an odd multiple of the first number of entries of the codebook of the pyramid vector quantizer.

Example 5. The method as in Example 4, wherein the odd multiple is one less than a power of two, and wherein decoding the compressed frame at the extended resolution achieves an additional bit depth based on the power of two.

Example 6. The method as in Example 1, wherein the set of extension bits representing data enabling the decoder to increase a resolution used by the decoder increases a bandwidth used by the decoder.

Example 7. The method as in Example 6, wherein decoding the compressed frame includes: determining that the codebook is larger than a threshold size; and in response to the determining, performing decoding using one of a pyramid vector quantizer or a cubic quantizer.

Example 8. The method as in Example 1, wherein the audio codec is an Opus codec, and the set of extension bits are stored in a padding layer of a data packet that includes multiple frames.

Example 9. The method as in Example 1, wherein the vector quantizer is configured to output coefficients for an inverse modified discrete cosine transform.

Example 10. A computer program product comprising a nontransitory storage medium, the computer program product including code that, when executed by processing circuitry, causes the processing circuitry to perform a method, the method comprising: receiving, by a decoder of an audio codec using a vector quantizer having a codebook that includes a first number of entries, a bitstream including a set of base bits representing a compressed frame of an audio signal; in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution using the extension of the codebook having the second number of entries; and in response to the decoder not receiving the set of extension bits, decoding the compressed frame of the audio signal at the initial resolution using the codebook having the first number of entries.

Example 11. The computer program product as in Example 10, wherein the vector quantizer is a pyramid vector quantizer.

Example 12. The computer program product as in Example 11, wherein the second number of entries of the extension of the codebook of the pyramid vector quantizer is an odd multiple of the first number of entries of the codebook of the pyramid vector quantizer.

Example 13. The computer program product as in Example 12, wherein the odd multiple is one less than a power of two, and wherein decoding the compressed frame at the extended resolution achieves an additional bit depth based on the power of two.

Example 14. The computer program product as in Example 11, wherein decoding the compressed frame includes: determining that the codebook is larger than a threshold size; and in response to the determining, replacing the pyramid vector quantizer with a cubic quantizer and performing decoding using the cubic quantizer.

Example 15. The computer program product as in Example 10, wherein the audio codec is an Opus codec, and the set of extension bits are stored in a padding layer of a data packet that includes multiple frames.

Example 16. An electronic apparatus, the electronic apparatus comprising: memory; and a processor coupled to the memory, the processor being configured to: receive, by a decoder of an audio codec using a vector quantizer having a codebook that includes a first number of entries, a bitstream including a set of base bits, the set of base bits representing a compressed frame of an audio signal; in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decode the compressed frame of the audio signal at the extended resolution using the extension of the codebook having the second number of entries; and in response to the decoder not receiving the set of extension bits, decode the compressed frame of the audio signal at the initial resolution using the codebook having the first number of entries.

Example 17. The electronic apparatus as in Example 16, wherein the vector quantizer is a pyramid vector quantizer.

Example 18. The electronic apparatus as in Example 17, wherein the second number of entries of the extension of the codebook of the pyramid vector quantizer is an odd multiple of the first number of entries of the codebook of the pyramid vector quantizer.

Example 19. The electronic apparatus as in Example 18, wherein the odd multiple is one less than a power of two, and wherein decoding the compressed frame at the extended resolution achieves an additional bit depth based on the power of two.

Example 20. The electronic apparatus as in Example 16, wherein the processor configured to decode the compressed frame is further configured to: determine that the codebook is larger than a threshold size; and in response to the determining, replace a pyramid vector quantizer with a cubic quantizer and performing decoding using the cubic quantizer.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the implementations described have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite example relationships described in the specification or shown in the figures.

As used in this specification, a singular form may, unless expressly indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method, comprising:
receiving, by a decoder of an audio codec using a vector quantizer having a codebook that includes a first number of entries, a bitstream including a set of base bits representing a compressed frame of an audio signal; and
in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution using the extension of the codebook having the second number of entries.

2. The method as in claim 1, wherein in response to the decoder not receiving the set of extension bits, decoding the compressed frame of the audio signal at the initial resolution using the codebook having the first number of entries.

3. The method as in claim 1, wherein the vector quantizer is a pyramid vector quantizer.

4. The method as in claim 3, wherein the second number of entries of the extension of the codebook of the pyramid vector quantizer is an odd multiple of the first number of entries of the codebook of the pyramid vector quantizer.

5. The method as in claim 4, wherein the odd multiple is one less than a power of two, and
wherein decoding the compressed frame at the extended resolution achieves an additional bit depth based on the power of two.

6. The method as in claim 1, wherein the set of extension bits representing data enabling the decoder to increase a resolution used by the decoder increases a bandwidth used by the decoder.

7. The method as in claim 6,
wherein decoding the compressed frame includes:
determining that the codebook is larger than a threshold size; and
in response to the determining, performing decoding using one of a pyramid vector quantizer or a cubic quantizer.

8. The method as in claim 1, wherein the audio codec is an Opus codec, and the set of extension bits are stored in a padding layer of a data packet that includes multiple frames.

9. The method as in claim 1, wherein the vector quantizer is configured to output coefficients for an inverse modified discrete cosine transform.

10. A computer program product comprising a nontransitory storage medium, the computer program product including code that, when executed by processing circuitry, causes the processing circuitry to perform a method, the method comprising:
receiving, by a decoder of an audio codec using a vector quantizer having a codebook that includes a first number of entries, a bitstream including a set of base bits representing a compressed frame of an audio signal;
in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decoding the compressed frame of the audio signal at the extended resolution using the extension of the codebook having the second number of entries; and
in response to the decoder not receiving the set of extension bits, decoding the compressed frame of the audio signal at the initial resolution using the codebook having the first number of entries.

11. The computer program product as in claim 10, wherein the vector quantizer is a pyramid vector quantizer.

12. The computer program product as in claim 11, wherein the second number of entries of the extension of the codebook of the pyramid vector quantizer is an odd multiple of the first number of entries of the codebook of the pyramid vector quantizer.

13. The computer program product as in claim 12, wherein the odd multiple is one less than a power of two, and
wherein decoding the compressed frame at the extended resolution achieves an additional bit depth based on the power of two.

14. The computer program product as in claim 11, wherein decoding the compressed frame includes:
determining that the codebook is larger than a threshold size; and
in response to the determining, performing decoding using one of a pyramid vector quantizer or a cubic quantizer.

15. The computer program product as in claim 10, wherein the audio codec is an Opus codec, and the set of extension bits are stored in a padding layer of a data packet that includes multiple frames.

16. An electronic apparatus, the electronic apparatus comprising:
memory; and
a processor coupled to the memory, the processor being configured to:
receive, by a decoder of an audio codec using a vector quantizer having a codebook that includes a first number of entries, a bitstream including a set of base bits, the set of base bits representing a compressed frame of an audio signal;
in response to the decoder receiving a set of extension bits that extends the codebook, the set of extension bits representing data enabling the decoder to increase a resolution used by the decoder to an extended resolution greater than an initial resolution by an extension of the codebook from the first number of entries to a second number of entries, decode the compressed frame of the audio signal at the extended resolution using the extension of the codebook having the second number of entries; and
in response to the decoder not receiving the set of extension bits, decode the compressed frame of the audio signal at the initial resolution using the codebook having the first number of entries.

17. The electronic apparatus as in claim 16, wherein the vector quantizer is a pyramid vector quantizer.

18. The electronic apparatus as in claim 17, wherein the second number of entries of the extension of the codebook of the pyramid vector quantizer is an odd multiple of the first number of entries of the codebook of the pyramid vector quantizer.

19. The electronic apparatus as in claim 18, wherein the odd multiple is one less than a power of two, and
wherein decoding the compressed frame at the extended resolution achieves an additional bit depth based on the power of two.

20. The electronic apparatus as in claim 16, wherein the processor configured to decode the compressed frame is further configured to:
determine that the codebook is larger than a threshold size; and
in response to the determining, performing decoding using one of a pyramid vector quantizer or a cubic quantizer.
